(19) United States
(12) Patent Application Publication
(10) Pub. No.: US 2009/0063565 A1
(43) Pub. Date: Mar. 5, 2009

(54) Job search in a geo-spatial enviornment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc,

(21) Appl. No.: 11/897,053

(22) Filed: Aug. 28, 2007

(51) Int. Cl. G06F 17/30; G06F 7/06

(52) U.S. Cl. 707/104.1; 707/E17.017; 707/E17.018

(57) ABSTRACT

A method and system of a job search in a geo-spatial environment are disclosed. In one embodiment, a method of conducting a job search includes obtaining candidate data (e.g., may be a name, a resume, an experience level, an education level and/or an employment preference, etc.) corresponding to a job search profile, determining a location associated with the job search profile based on the candidate data, storing the job search profile in a candidate repository, processing a search request from a user associated with the job search profile, obtaining a search radius associated with the location from the user, obtaining at least one employer profile based on the search radius, and displaying the employer profile to the user on a geo-spatial map. The method may further include obtaining a search parameter from the user, and obtaining the employer profile based on the search radius and the search parameter.

### FIELD OF TECHNOLOGY

This disclosure relates generally to the technical fields of communications and, in one example embodiment, to a method and system of job search in a geo-spatial environment.

### BACKGROUND

Job search engines are websites that facilitate job hunting. The job search engines may allow users to store resumes on the site and/or submit the resumes to potential employers. Similarly, employers may post job listings and/or search for potential employees on the job search engines. The job search engine may encompass a variety of occupations and/or job types or serve a niche market, such as engineering, legal services, insurance, social work, and/or teaching. In addition, the job search engines may cater to a specific geographic region, level of education, and/or skill level.

The job search engines may include separate interfaces for candidates and employers. The candidates may be allowed to perform functions such as browsing and/or searching for job listings, posting, editing, and/or updating of resumes and/or cover letters, updating user profiles and preferences, contacting potential employers. submitting resumes and/or cover letters to the potential employers, etc. The employers may post, edit, and/or update job listings, access posted resumes and/or cover letters, search resumes for matches with job listings, contact candidates, etc.

The job search engines may be implemented by traditional job boards. For example, a job board may provide job search capabilities for the candidates and the employers to find desired positions and the potential employees, respectively. Alternatively, the job search engines may be implemented to search across multiple job boards. Other job search engines may index directly from the employers' websites, thus bypassing traditional job boards altogether and/or allowing the candidates to find new positions that may not be advertised on the traditional job boards.

Despite the development of specialized and/or indexed job search engines, the candidates and/or the employers may still have difficulty finding an ideal match for a position. In other words, the candidates may not adequately find ideal positions using typical search parameters offered by the job search engines. For example, the candidates may seek positions within a certain commute distance and/or time from home. The ideal commute distance and/or time for a candidate may be based on a number of factors, such as traffic conditions, mode of transportation, cost of transportation, willingness to devote time to commuting, etc. However, current job search methods may be limited to returning results from a particular city, region, and/or state. As a result, the candidates may have difficulty using the job search engines to find positions that alleviate problems associated with commuting to work.

### SUMMARY

A method and system of job search in a geo-spatial environment are disclosed. In one aspect, a method of conducting a job search includes obtaining candidate data (e.g., name, resume, cover letter, experience level, education level, and/or employment preference, etc.) corresponding to a job search profile, determining a location associated with the job search profile (e.g., may be a non-residential location) based on the candidate data, storing the job search profile in a candidate repository, processing a search request from a user associated with the job search profile, obtaining a search radius associated with the location (e.g., may be a distance from the location and/or a commute time from the location) from the user, obtaining at least one employer profile based on the search radius, and displaying the employer profile to the user on a geo-spatial map.

The method may further include obtaining a search parameter from the user, and obtaining the employer profile based on the search radius and the search parameter (e.g., job category, job type, keyword, salary range, experience level, and/or education level, etc.).

In another aspect, a community network includes a candidate repository including a plurality of job search profiles, an employer repository including a plurality of employer profiles (e.g., may include employer name, employer description, location, education level, experience level, job title, job description, compensation, and/or candidate preference, etc.), a geo-spatial repository including a plurality of locations on a geo-spatial map, and a job management module configured to determine a first of the locations associated with one of the job search profiles (e.g., may include name, resume, cover letter, experience level, education level, and/or employment preference, etc.), process a search request from a first user associated with the one of the job search profiles, obtain a first search radius associated with the first of the locations (e.g., may be a distance from the location and/or a commute time from the first of the locations) from the first user, obtain the employer profiles based on the first search radius, and display the employer profiles to the first user on the geo-spatial map.

The job management module may be further configured to obtain a first search parameter (e.g., may include job category, job type, keyword, salary range, experience level, and/or education level, etc.) from the first user, and obtain the employer profiles based on the first search radius and the first search parameter.

In addition, the job management module may be configured to determine a second of the locations associated with one of the employer profiles, process a search request from a second user associated with the one of the employer profiles, obtain a second search radius associated with the second of the locations from the second user, obtain the job search profiles based on the second search radius, and display the job search profiles to the second user on the geo-spatial map. The job management module may also be configured to obtain a second search parameter from the second user, and obtain the job search profiles based on the second search radius and the second search parameter.

In yet another aspect, a method of conducting a job candidate search includes obtaining employer data (e.g., may include employer name, employer description, location, education level, experience level, job title, job description, compensation, and/or candidate preference, etc.) corresponding to an employer profile, determining a location associated with the employer profile based on the employer data, storing the employer profile in an employer repository, processing a search request from a user associated with the employer profile, obtaining a search radius associated with the location (e.g., may be a distance from the location and/or a commute time from the first of the locations) from the user, obtaining at least one of the job search profile based on the search radius, and displaying the job search profile to the user on a geo-spatial map.

The method may further include obtaining a search parameter (e.g., may include job category, job type, keyword, salary range, experience level, and/or education level) from the user, and obtaining the job search profile based on the search radius and the search parameter.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community network enabling a job search and a candidate search on a geo-spatial map, according to one embodiment.

FIG. 2A is a user interface view displaying an employer profile to a user performing a job search on the geo-spatial map, according to one embodiment.

FIG. 2B is a user interface view displaying a job search profile to the user on the geo-spatial map, according to one embodiment.

FIG. 2C is a user interface view displaying a job search profile corresponding to a candidate search associated with an entity on the geo-spatial map, according to one embodiment.

FIG. 3 is a block diagram representation illustrating information associated with the job search profile, according to one embodiment.

FIG. 4 is a block diagram representation illustrating information associated with the employer profile, according to one embodiment.

FIG. 5 is a flow chart of searching a job associated with an employer profile based on a search radius and search parameters on the geo-spatial map, according to one embodiment.

FIG. 6 is a flow chart of searching a candidate associated with a job search profile based on a search radius and search parameters on the geo-spatial map, according to one embodiment.

FIG. 7 is a diagrammatic system view of a data processing system in which any of the embodiments disclosed herein may be performed, according to one embodiment.

FIG. 8A is a process flow of displaying employer profiles to a user on the geo-spatial map, according to one embodiment.

FIG. 8B is a continuation of the process flow of FIG. 8A illustrating additional processes, according to one embodiment.

FIG. 9A is a process flow of displaying job search profiles to a user on the geo-spatial map, according to one embodiment.

FIG. 9B is a continuation of the process flow of FIG. 9A illustrating additional processes, according to one embodiment.

Other features of the present embodiments will be apparent from the accompanying drawings and from the detailed description that follows.

### DETAILED DESCRIPTION

A method and system of job search in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

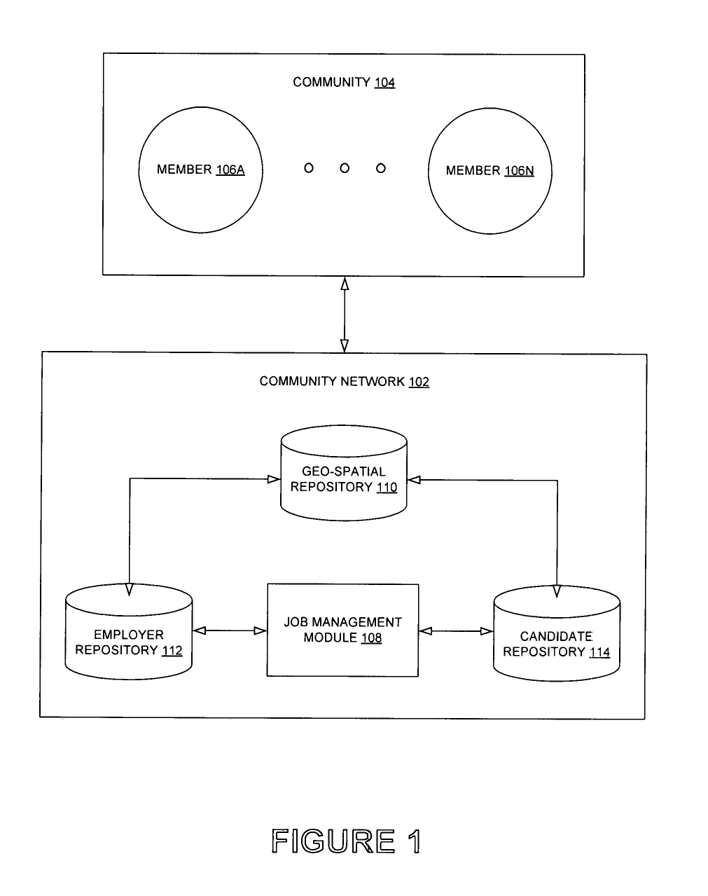

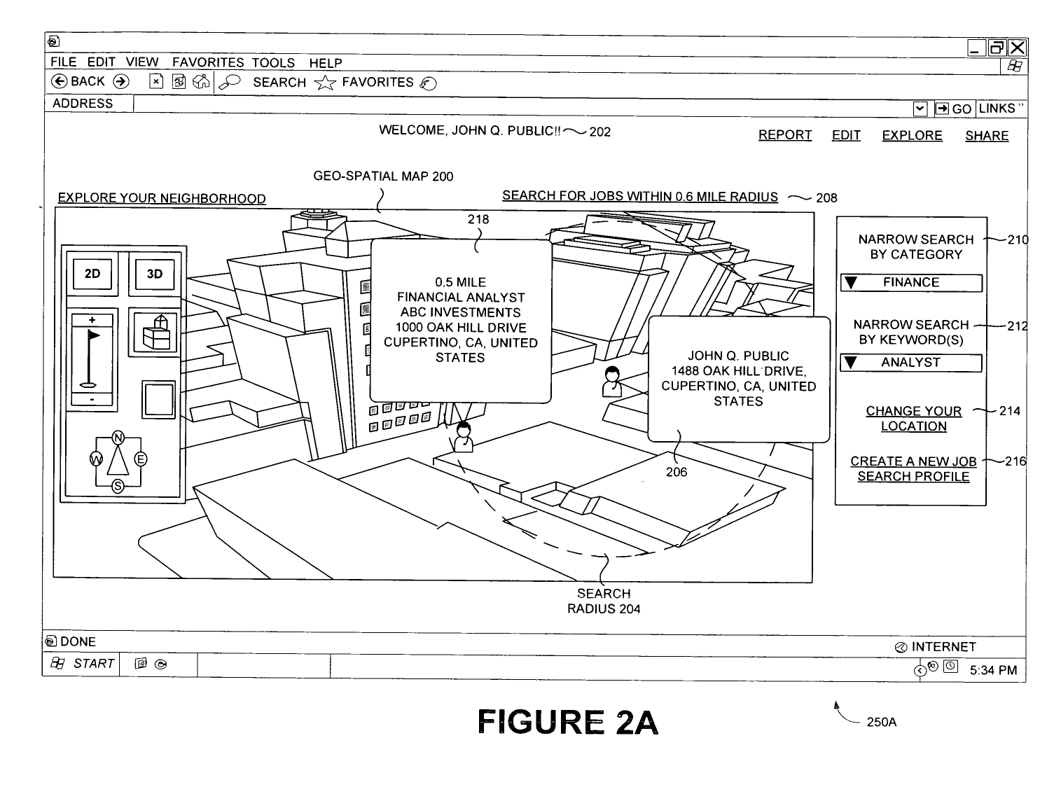

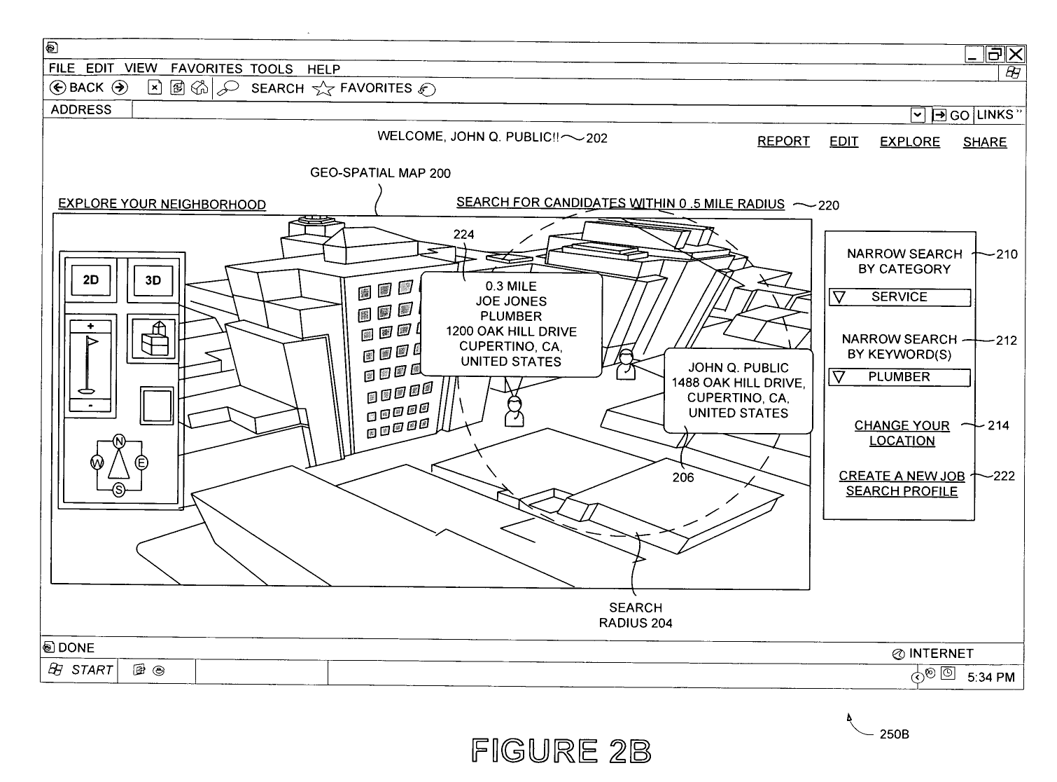

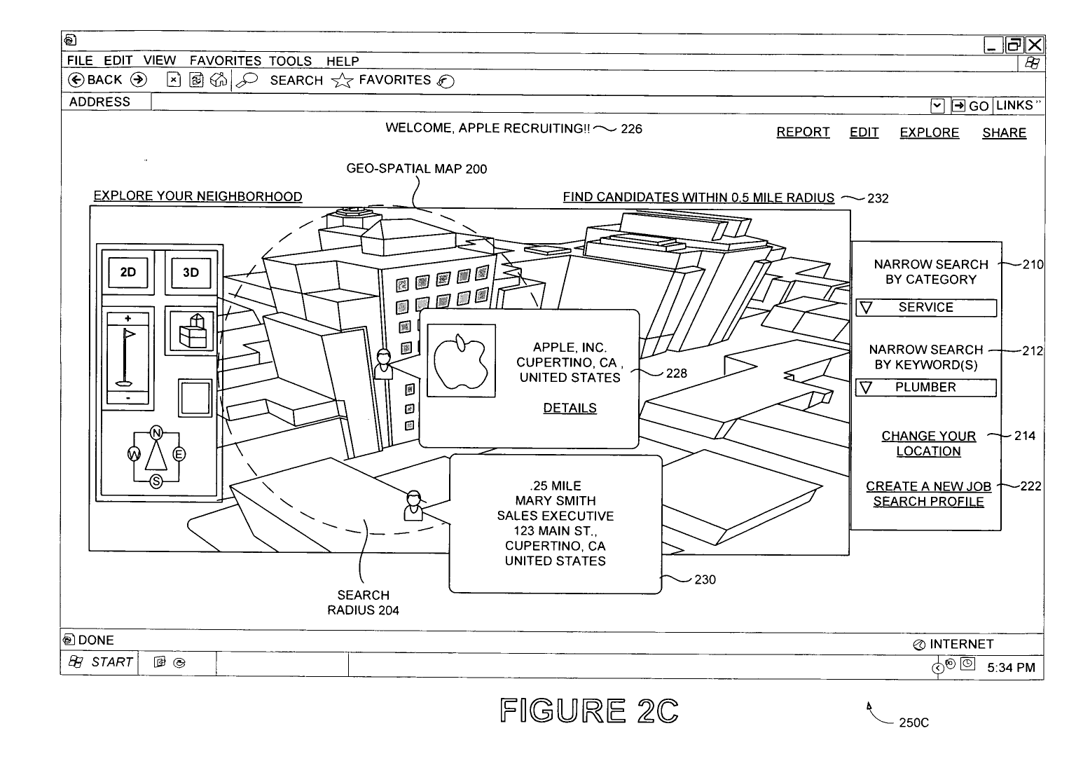

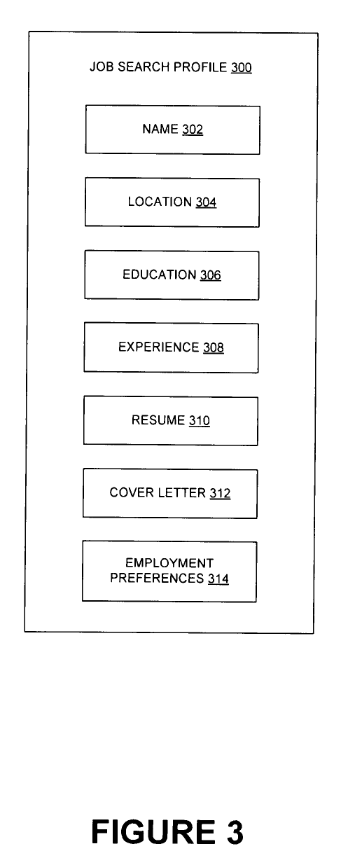

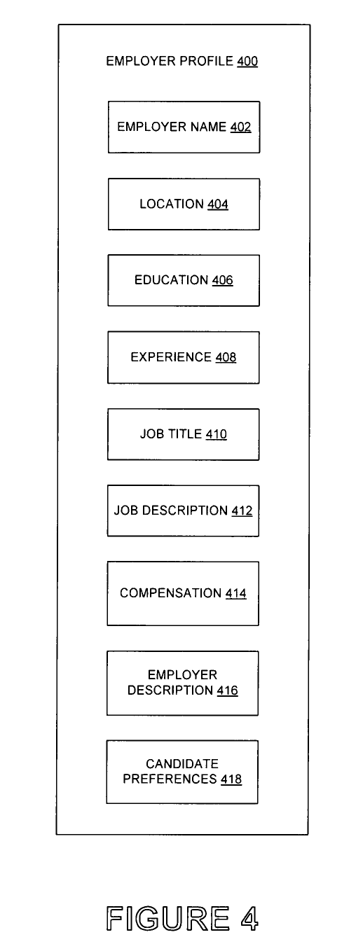

In one embodiment, a method of conducting a job search includes obtaining candidate data (e.g., using the candidate repository 114 of FIG. 1) corresponding to a job search profile (e.g., the job search profile 300 of FIG. 3), determining a location associated with the job search profile 300 based on the candidate data, and storing the job search profile 300 in a candidate repository (e.g., the candidate repository 114 of FIG. 1). The method includes processing a search request from a user (e.g., candidate) associated with the job search profile 300, obtaining a search radius (e.g., the search radius 204 of FIG. 2A) associated with the location from the user, obtaining an employer profile (e.g., the employer profile 400 of FIG. 4) based on the search radius 204, and displaying the employer profile 400 (e.g., using the job management module 108 of FIG. 1) to the user on a geo-spatial map (e.g., the geo-spatial map 200 of FIG. 2A).

In another embodiment, a community network (e.g., the community network 102 of FIG. 1) includes a candidate repository 114 including a number of job search profiles (e.g., the job search profile 300 of FIG. 3), an employer repository (e.g., the employer repository 112 of FIG. 1) including a number of employer profiles (e.g., the employer profile 400 of FIG. 4), and a geo-spatial repository (e.g., the geo-spatial repository 110 of FIG. 1) including a number of locations on a geo-spatial map 200.

The community network 102 also includes a job management module (e.g., the job management module 108 of FIG. 1) configured to determine a first location associated with a job search profile 300, process a search request from a first user (e.g., candidate) associated with the job search profile 300, obtain a first search radius (e.g., the search radius 204 of FIG. 2A) associated with the first locations from the first user, obtain the employer profile (e.g., the employer profile 400 of FIG. 4) based on the first search radius 204, and display the employer profile 400 to the first user on the geo-spatial map 200.

In yet another embodiment, a method of conducting a job candidate search includes obtaining employer data (e.g., the employer name 402, the location 404, the education 406, and/or experience 408, etc.) corresponding to an employer profile (e.g., the employer profile 400 of FIG. 4), determining a location associated with the employer profile 400 based on the employer data, storing the employer profile 400 in an employer repository (e.g., the employer repository 1 12 of FIG. 1), processing a search request from a user (e.g., employer) associated with the employer profile 400, obtaining a search radius (e.g., the search radius 204 of FIG. 2) associated with the location from the user, obtaining a job search profile (e.g., the job search profile 300 of FIG. 3) based on the search radius 204, and displaying the job search profile 300 (e.g., using the job management module 108 of FIG. 1) to the user on a geo-spatial map 200.

FIG. 1 is a system view of a community network 102 enabling a job search and a candidate search on a geo-spatial map (e.g., the geo-spatial map 200 of FIGS. 2B and 2C), according to one embodiment. Particularly, FIG. 1 illustrates the community network 102, a community 104, members 106A-N, a job management module 108, a geo-spatial repository 110, an employer repository 112 and a candidate repository 114, according to one embodiment.

The community network 102 may be a network formed by an association of the members 106A-N in the community 104. The community 104 may refer to a group of members 106A-N located in a specific geographic region. The members 106A-N may include individuals (e.g., employers, candidates, etc.) searching for desired positions and/or potential employees. The members 106A-N may be connected with each other through the community network 102. In one or more embodiments, the member 106 of the community network 102 performing any one of a job search and a candidate search is referred as a user (e.g., candidate, employer).

The job management module 108 may enable a job search and/or a candidate search based on a search parameter and/or a search radius (e.g., the search radius 204 of FIGS. 2A, 2B and 2C). In addition, the job management module 108 may obtain and/or display profiles (e.g., the job search profile 300, the employer profile 400, etc.) to users (e.g., employer, candidate, consultants, etc.) on the geo-spatial map 200. For example, the job search may include obtaining and displaying an employer profile(s) (e.g., the employer profiles 400 of FIG. 4) based on a search request of a candidate. In addition, the candidate search may include obtaining and displaying a job search profile(s) (e.g., the job search profile 300 of FIG. 3) to an employer (e.g., based on a search request of the employer).

In one example embodiment, the search request may be a request made by the member 106 (e.g., anyone of the employer and candidate) based on the search parameters (e.g., job category, job type, and/or experience, etc.) and/or the search radius 204. For example, the search radius 204 may be a geographical distance through which a location of the candidate and the employer are separated. In another example embodiment, the search radius 204 may be a commute time from a location specified by the candidate.

The geo-spatial repository 110 may be a database including location information associated with the members 106A-N of the community 104. The employer repository 112 may be a database including the employer profiles 400. The candidate repository 114 may be a database including the job search profiles 300.

In the example embodiment illustrated in FIG. 1, the community network 102 includes the job management module 108, the geo-spatial repository 110, the employer repository 112 and the candidate repository 114, communicating with each other.

In accordance with one or more embodiments, the job search profiles 300 (e.g., may include name, resume, cover letter, experience level, education level, and/or employment preference, etc.) may be stored in the candidate repository 114 and the employer profiles 400 may be stored in the employer repository 112. The geo-spatial repository 110 may include a number of locations (e.g., associated with the job search profiles 300 and employer profiles 400) on the geo-spatial map 200.

In one example embodiment, the job management module 108 may be configured to determine a first location associated with a job search profile 300 and process a search request from a first user (e.g., candidate) associated with the job search profile 300. The job management module 108 may be further configured to obtain a first search radius 204 (e.g., may be a distance from the first location and/or a commute time from the first location) associated with the first location from the first user.

In addition, the job management module 108 may be configured to obtain the employer profiles 400 (e.g., may include employer name, employer description, location, education level, experience level, job title, job description, compensation, and/or candidate preference, etc.) based on the first search radius 204 and display the employer profiles 400 to the first user on the geo-spatial map 200. The job management module 108 may be yet configured to obtain a first search parameter (e.g., may include job category, job type, keyword, salary, experience level, and/or education level, etc.) from the first user and obtain the employer profiles 400 based on the first search radius 204 and the first search parameter.

In another example embodiment, the job management module 108 may be configured to determine a second location associated with an employer profile 400 and process a search request (e.g., may include search radius 204) from a second user (e.g., employer) associated with the employer profile 400. The job management module 108 may also be configured to obtain a second search radius 204 associated with the second location from the second user.

In addition, the job management module 108 may be configured to obtain job search profiles 300 (e.g., may include name, resume, cover letter, experience level, education level, and/or employment preference, etc.) based on the second search radius 204 and display the job search profiles 300 to the second user on the geo-spatial map 200. Further, the job management module 108 may be configured to obtain a second search parameter from the second user and obtain the job search profiles 300 based on the second search radius 204 and the second search parameter.

FIG. 2A is a user interface view 250A displaying an employer profile (e.g., the employer profile 400 of FIG. 4) to a user (e.g., candidate) performing a job search on a geo-spatial map 200, according to one embodiment. Particularly, FIG. 2A illustrates the geo-spatial map 200, a welcome message 202, a search radius 204, a user profile block 206, a search option 208, a narrow search by category option 210, a narrow search by keyword(s) option 212, a change your location option 214, a create a new job search profile option 216 and an employer profile block 218, according to one embodiment.

The geo-spatial map 200 may graphically display member data (e.g., name and/or address) associated with the members 106A-N (e.g., may include candidates, employers, job consultants, etc.). For example, the member data may include candidate data corresponding to a job search profile 300 and/or employer data corresponding to the employer profile 400. The welcome message 202 may display a unique identifier (e.g., first name, last name, user name, code, etc.) of the user associated with the webpage. In other words, the welcome message 202 may be displayed to the user upon logging into the webpage.

The search radius 204 may be a distance and/or a travel time obtained from the user associated with the job search profile 300. The user may perform an employer profiles search within the search radius 204. In one example embodiment, the search radius 204 may be associated with a location obtained from the user. The user profile block 206 may display profile information associated with the user (e.g., job seeker), performing a job search within the search radius 204. For example, the profile information may include name, address and/or location associated with the user. The search option 208 may enable the user to search the employer profiles 400 within a specified radius (e.g., the search radius 204 of FIG. 2A).

The narrow search by category option 210 may enable the user to perform a narrow search associated with the employer profiles 400 within the search radius 204 based on a job category (e.g., finance, information technology, legal, marketing, etc.). The narrow search by keyword(s) option 212 may enable the user to search employer profiles within the search radius 204 using keywords (e.g., doctor, project manager, patent analyst, junior software engineer, etc.) associated with the job category.

The change your location option 214 may enable the user to search employer profiles 400 associated with other locations on the geo-spatial map 200. In one example embodiment, the user may specify a different search radius 204 while changing the location associated with the job search. The create a new job search profile option 216 may enable the user to create, modify and/or update profile information and/or preferences in order to obtain desired employers within the search radius 204 associated with the location. The employer profile block 218 may display profile information associated with the employer located within the search radius 204.

In the example embodiment illustrated in FIG. 2A, the user interface view 250A displays the employer profile block 218 (e.g., based on the search radius 204 (e.g., 0.5 mile radius) and/or search parameters) to the user (e.g., John Q. Public) on the geo-spatial map 200. The user interface view 250A also displays the welcome message 202 associated with the user (e.g., John Q. Public). The welcome message 202 displays “Welcome, John Q. Public” representing a webpage associated with John Q. Public.

The user profile block 206 displays name of the user “John Q. Public” and address “1488 Oak Hill Drive, Cupertino, Calif., United States”. For example, John Q. Public may search employers (e.g., recruiting financial analyst) within a search radius of 0.6 mile using the search option 208. In addition, John Q. Public may narrow down the job search by specifying category as “Finance” and keyword as “Analyst”. In one example embodiment, John Q. Public is searching for employer recruiting Financial Analyst within the search radius 204 associated with location obtained from the user on a geo-spatial map 200.

The employer profile block 218 displays search radius 204 “0.5 mile”. designation “Financial Analyst” and name and address of the employer “ABC Investments, 1000 Oak Hill Drive, Cupertino, Calif., United States” based on the search request of John Q. Public. As illustrated in the example embodiment of FIG. 2A, the employer associated with employer profile 400 is located at a distance of 0.5 mile away from the location (e.g., 1000 Oak Hill Drive) obtained from John Q. Public. If the desired employer profiles 400 are not obtained within the search radius 204 of 0.6 mile (e.g., specified by John), John Q. Public may search for the desired employer profiles 400 in other locations on the geo-spatial map 200 using the change your location option 214.

For example, a location (e.g., may include a non-residential location) associated with the job search profile 300 may be determined based on the candidate data. A search request from the user associated with the job search profile 300 may be processed (e.g., using the job management module 108 of FIG. 1). A search radius 204 associated with the location (e.g., may be a distance from the location and/or commute time from the location) may be obtained from the user (e.g., John Q. Public).

The employer profile 400 may be obtained (e.g., through employer repository 112 of FIG. 1) based on the search radius 204. The employer profile 400 may be displayed to the user on the geo-spatial map 200. The search parameter (e.g., may include job category, job type, keyword, salary range, experience level, and/or education level, etc.) may be obtained from the user. In addition, the employer profile 400 may be obtained based on the search radius 204 and/or the search parameter.

FIG. 2B is a user interface view 250B displaying a job search profile (e.g., the job search profile 300 of FIG. 3) to the user on the geo-spatial map 200, according to one embodiment. Particularly, FIG. 2B illustrates the geo-spatial map 200, the welcome message 202, the search radius 204, the user profile block 206, the narrow search by category option 210, the narrow search by keyword(s) option 212, the change your location option 214, a create a new employer profile option 222 and a profile block 224, according to one embodiment.

The search option 220 may enable the user (e.g., employer) to search candidate profiles within a threshold search radius (e.g., 0.25 miles, 0.5 miles, 0.75 miles, etc.). The create a new employer profile option 222 may enable the user (e.g., the employer) to perform functions like posting, updating and/or editing job listings in the employer profiles 400 (e.g., to find potential employees). The profile block 224 may display profile information associated with the candidate based on a search request of the user. For example, the profile information may include name, address, profession, etc.

In the example embodiment illustrated in FIG. 2B, the user interface view 250B displays the profile information associated with the user “John Q. Public” (e.g., employer). The user interface view 200B also displays the welcome message 202 associated with John Q. Public. The user profile block 206 displays name of the user “John Q. Public” and address “1488 Oak Hill Drive, Cupertino, Calif., United States”. For example, John Q. Public may search for a plumber (e.g., candidate) within a search radius 204 of 0.5 mile using the search option 220. John Q. Public may narrow down the candidate search by specifying category as “Service” and keyword as “Plumber”.

The profile block 224 displays distance of separation “0.3 mile”, name of candidate “Joe Jones”, occupation “Plumber” and address “1200 Oak Hill Drive, Cupertino, Calif., United States”. As illustrated in the example embodiment of FIG. 2B, the plumber associated with the employer search (e.g., performed by John Q. Public) is located at a distance of 0.3 mile from the location of John Q. Public. If the desired job search profiles 300 are not obtained within the search radius 204 of 0.5 mile, John Q. Public may search for the desired job search profiles 300 in other locations on the geo-spatial map 200 using the change your location option 214. In addition, John Q. Public may create, modify, and/or update the profile using the create a new employer profile option 222. For example, John Q. Public may also search for driver, gardener, etc. by creating one or more employer profiles 400.

In one example embodiment, John Q. Public searches employer profiles (e.g., using the search parameters) associated with the location (Oak Hill Drive) within a specified search radius 204 and/or commute time from John Q. Public's location (e.g., as illustrated in FIG. 2A). In another example embodiment, John Q. Public searches candidates (e.g., plumber) within a search radius 204 (e.g., 0.5 mile) associated with a location (e.g., selected by John Q. Public) based on search parameters (e.g., as illustrated in FIG. 2B).

FIG. 2C is a user interface view 250C displaying a job search profile corresponding to a candidate search associated with an entity on the geo-spatial map 200, according to one embodiment. Particularly, FIG. 2C illustrates the geo-spatial map 200, the search radius 204, the narrow search by category option 210, the narrow search by keywords(s) option 212, the change your location option 214, the create a new employer profile option 222, a welcome message 226, an employer profile block 228, a candidate profile block 230 and a search option 232, according to one embodiment.

The welcome message 226 may display a unique identifier (e.g., name, user name, slogan, logo, code, etc.) of entity (e.g., company, business, organization, etc.) associated with the webpage. For example, the entity may be a user (e.g., employer) searching candidates associated with the job search profile 300 within a specified radius on the geo-spatial map 200. The employer profile block 228 may display profile details (e.g., name, address, and/or other information) associated with the entity conducting the candidate search.

The candidate profile block 230 may display profile information (e.g., may include name, address, profession, distance of separation, etc.) associated with the candidate corresponding to the search request of the entity (e.g., user). The search option 232 may enable the entity to search for the candidates associated with the job search profiles 300 within a specified radius associated with the location.

In the example embodiment illustrated in FIG. 2C, the user interface view 250C displays the job search profile of the candidate (e.g., as illustrated in the candidate profile block 230 of FIG. 2) to the entity (e.g., Apple, Inc.) on the geo-spatial map 200. The user interface view 200C also displays the welcome message 226 associated with the entity. The welcome message 226 displays “Welcome, Apple Recruiting!!” representing that the homepage is associated with the entity “Apple,Inc.”. The employer profile block 228 displays name of the entity “Apple, Inc.”, address “Cupertino, Calif., United States”, and other details associated with the entity.

For example, Apple, Inc. may search for sales executives within a search radius of 0.5 miles using the search option 232. Apple, Inc. may narrow down the search candidate search by specifying category as “Sales” and keyword as “Manager”. In one example embodiment, Apple, Inc. is searching for the sales executive within 0.5 miles from the location of the entity.

The candidate profile block 230 displays distance from the location “0.25 mile”, name of candidate “Mary Smith, Sales Executive”, address “123 Main St., Cupertino, Calif., United States” located 0.25 mile away from the location associated with Apple, Inc. If the desired job search profile(s) 300 is not obtained within the search radius 204 of 0.5 mile, the entity may search for the desired job search profiles 300 in other locations on the geo-spatial map 200 using the change your location option 214. In addition, Apple, Inc. may create, modify, and/or update the profile using the create a new employer profile option 222.

In accordance with one or more embodiments, a location associated with the employer profile 400 may be determined (e.g., using the job management module 108 of FIG. 1) based on employer data. A search request from the user (e.g., employer) associated with the employer profile 400 may be processed. A search radius 204 associated with the location (e.g., may be a distance from a location and/or a commute time from a location, etc.) may be obtained from the user and a job search profile 300 may be obtained based on the search radius 204. The job search profile 300 may be displayed to the user on the geo-spatial map 200. A search parameter(s) (e.g., may include job category, job type, keyword, salary range, experience level, and/or education level, etc.) may be obtained from the user. The job search profile 300 may be obtained based on the search radius 204 and/or the search parameter(s).

FIG. 3 is a block diagram representation illustrating information associated with a job search profile 300, according to one embodiment. Particularly, FIG. 3 illustrates a name block 302, a location block 304, an education block 306, an experience block 308, a resume block 310, a cover letter block 312 and employment preferences block 314, according to one embodiment.

The block diagram may display a name of a candidate in the name block 302, a location information in the location block 304, an education level in the education block 306, an experience level associated with the candidate in the experience block 308. The resume block 310 may display details which include summary or listing of relevant job experience and/or education usually displayed for the purpose of searching jobs (e.g., through community network 102 of FIG. 1). In one example embodiment, the candidate may upload resume associated with the job search profile 300 in the resume block 310. The cover letter block 312 may display a brief introduction of the candidate's profile corresponding to a job search. The employment preferences block 314 may enable the candidate to specify preferences (e.g., may include nature of job, field, job location, salary, etc.) corresponding to the job search profile 300. Employers may search for the candidate based on the preferences specified in the employment preferences block 314.

In the example embodiment illustrated in FIG. 3, the block diagram representation displays various information associated with candidate data (e.g., stored in the candidate repository 114) associated with the job search profile 300. Employers may search the candidates based on name, location, education, experience, resume, cover letter and/or employment preferences, etc. As a result, the candidate data (e.g., may include name, resume, cover letter, experience level, education level, and/or employment preference, etc.) corresponding to the job search profile 300 may be displayed to the potential employers on the geo-spatial map 200.

FIG. 4 is a block diagram representation illustrating information associated with an employer profile 400, according to one embodiment. Particularly, FIG. 4 illustrates an employer name block 402, a location block 404, an education block 406, an experience block 408, a job title block 410, a job description block 412, a compensation block 414, an employer description block 416 and candidate preferences block 418, according to one embodiment.

The block diagram may display a name of an employer in the employer name block 402, location information in the location block 404, qualification details required in the education block 406, an experience level in the experience block 408. The job title block 410 may display a type of occupation and/or requirement associated with the employer profile. For example, the type of occupation may include work time, type of field such as marketing, software, patent, etc. The job description block 412 may display a summary of a job, including the nature of work performed (e.g., duties and/or responsibilities), working conditions, key duration roles and/or level (e.g., skill, effort, etc.).

The compensation block 414 may display a list of compensations (e.g., base salary, shot-term incentives, long-term incentives, employee benefits, perquisites, relocation charges, etc.) associated with the job. The employer description block 416 may include background, history and/or details associated with an entity (e.g., patron, company, business, organization, etc.). The candidate preferences block 418 may enable the employers to specify preferences (e.g., may include nature of job, field, job location, salary, etc.) corresponding to the employer profile 400. Candidates (e.g., job seekers) may search desired position (e.g., desired job) based on the preferences specified in the candidate preferences block 418. In one example embodiment, the candidate preferences block 418 may include preferences such as age, expertise level, location, commitment level, willingness to work in night shifts, proficiency levels, etc.

In the example embodiment illustrated in FIG. 4, the block diagram representation illustrates information associated with the employer profile 400 (e.g., stored in the employer repository 112 of FIG. 1). Candidates may search a potential employer (e.g., may be associated with the employer profile 400) by name, description, location, education, experience, job title, job description, compensation and/or candidate preferences associated with the employer profile 400. As a result, the employer data (e.g., employer name, employer description, location, education level, experience level, job title, job description, compensation, and/or candidate preference, etc.) corresponding to the employer profile 400 may be displayed to the candidate on the geo-spatial map 200.

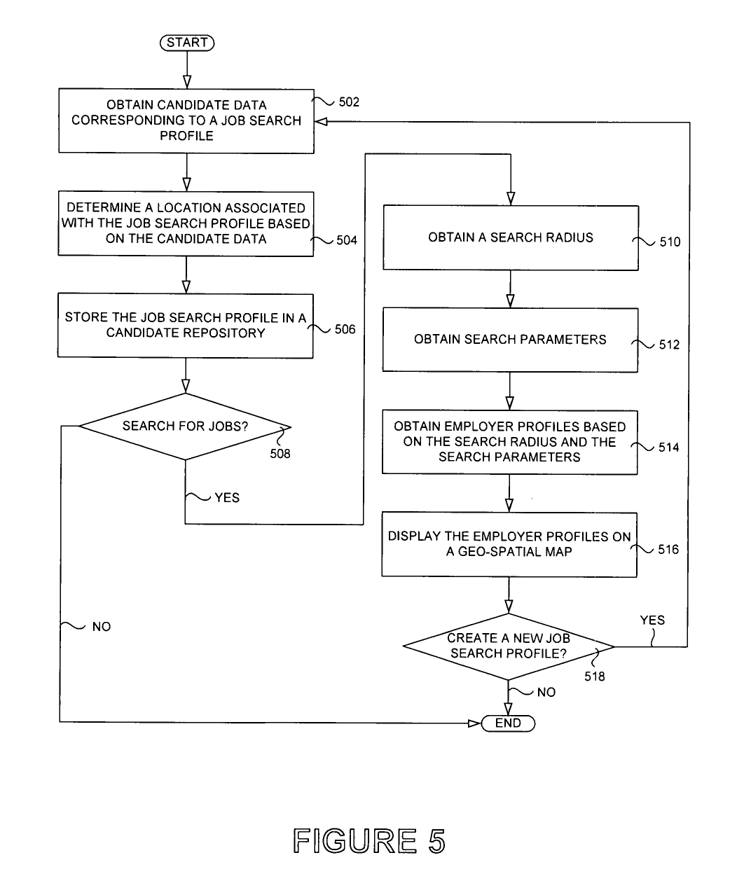

FIG. 5 is a flow chart of searching a job associated with an employer profile (e.g., the employer profile 400 of FIG. 4) based on a search radius (e.g., the search radius 204 of FIG. 2A) and search parameters on a geo-spatial map (e.g., the geo-spatial map 200 of FIG. 2A), according to one embodiment. In operation 502, candidate data corresponding to a job search profile (e.g., the job search profile 300 of FIG. 3) is obtained. For example, the candidate data may include a name, resume, cover letter, experience level, and/or educational qualification, etc. In operation 504, a location associated with the job search profile 300 is determined (e.g., using the geo-spatial repository 110 and the candidate repository 114 of FIG. 1) based on the candidate data.

In operation 506, the job search profile 300 is stored in a candidate repository (e.g., the candidate repository 114 of FIG. 1). In operation 508, a condition is determined whether the candidate is willing to search jobs or not. If the user is not willing to search the jobs, then the process may terminate. If the user has selected to search for jobs, then a search radius (e.g., the search radius 204 of FIG. 2A) is obtained from the candidate in operation 510. For example, the search radius 204 may be a radius specified by the candidate to search employer profiles 400 within the radius on a geo-spatial map (e.g., the geo-spatial map 200 of FIG. 2A).

In operation 512, search parameters are obtained from the candidate. For example, the search parameter may include a job category, job type, keyword, salary range, experience level, and/or education level, etc. In operation 514, employer profiles 400 are obtained based on the search radius 204 and the search parameters. For example, the employer profiles 400 may be displayed within the search radius 204 on the geo-spatial map 200 (e.g., corresponding to the search parameters and the search radius 204 specified by the candidate).

In operation 516, the employer profiles 400 are displayed on the geo-spatial map 200 (e.g., using the job management module 108 of FIG. 1). In operation 518, a condition is determined whether the candidate wishes to create a new job search profile (e.g., using create a new job search profile option 216 of FIG. 2A). If the candidate is not willing to create the new job search profile 300, then the process may terminate. However, if the candidate opts to create the new job search profile 300, then process may be routed back to operation 502.

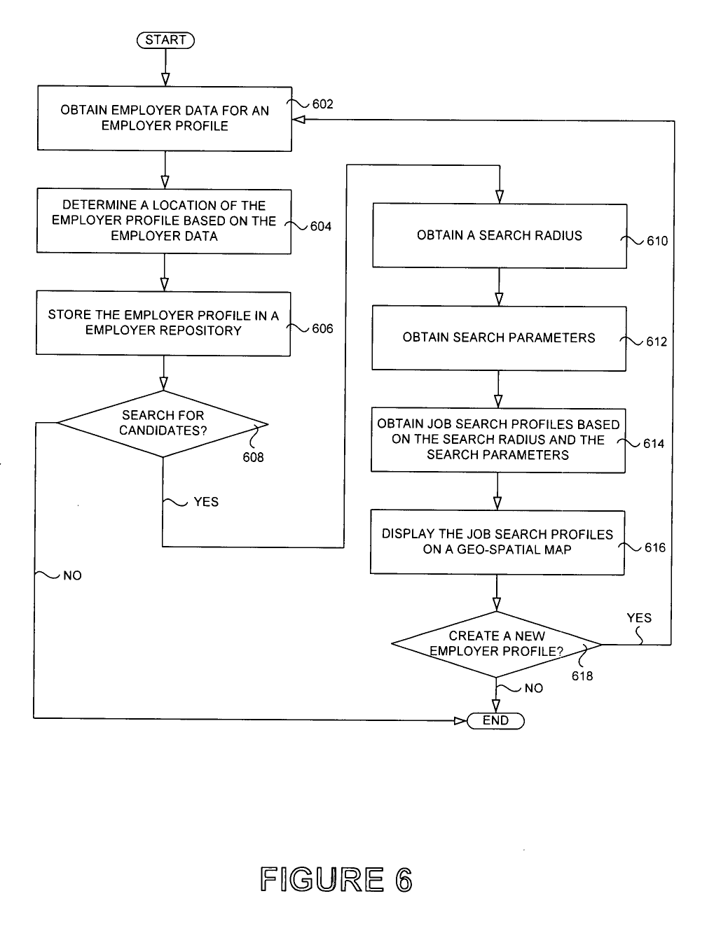

FIG. 6 is a flow chart of searching a candidate associated with a job search profile (e.g., the job search profile 300 of FIG. 3) based on a search radius (e.g., the search radius 204 of FIGS. 2B and 2C) and search parameters on a geo-spatial map (e.g., the geo-spatial map 200 of FIG. 2C), according to one embodiment. In operation 602, employer data for an employer profile (e.g., the employer profile 400 of FIG. 4) is obtained. For example, the employer data may include an employer name, employer description, location, education level, experience level, job title, job description, compensation, and/or candidate preference, etc.

In operation 604, a location of the employer profile 400 is determined (e.g., using the geo-spatial repository 110 and the employer repository 112 of FIG. 1) based on the employer data. In operation 606, the employer profile 400 is stored in an employer repository (e.g., the employer repository 112 of FIG. 1). In operation 608, a condition is determined whether an employer has opted search for candidates (e.g., through search option 232 of FIG. 2C). If the employer has not selected the search for candidates option, then the process may terminate. If the user has selected search for candidate option, then a search radius (e.g., the search radius 204 of FIGS. 2A, 2B and 2C) is obtained from the employer in operation 610. For example, the search radius 204 may be a radius specified by the employer to search candidates within the radius associated with the location.

In operation 612, the search parameters are obtained. For example, the search parameters may include a job category, job type, keyword, salary range, experience level, and/or education level, etc. In operation 614, the job search profiles 300 are obtained (e.g., using the job management module 108 of FIG. 1) based on the search radius 204 and the search parameters.

In operation 616, the job search profiles 300 are displayed on a geo-spatial map (e.g., the geo-spatial map 200 of FIG. 2C). In operation 618, a condition is determined whether the employer wishes to create a new employer profile (e.g., using the create a new employer profile option 222 of FIGS. 2B and 2C). If the create a new employer profile option is not selected, then the process may be terminate. However, if the create new employer profile option is selected, then the process may be routed back to operation 602.

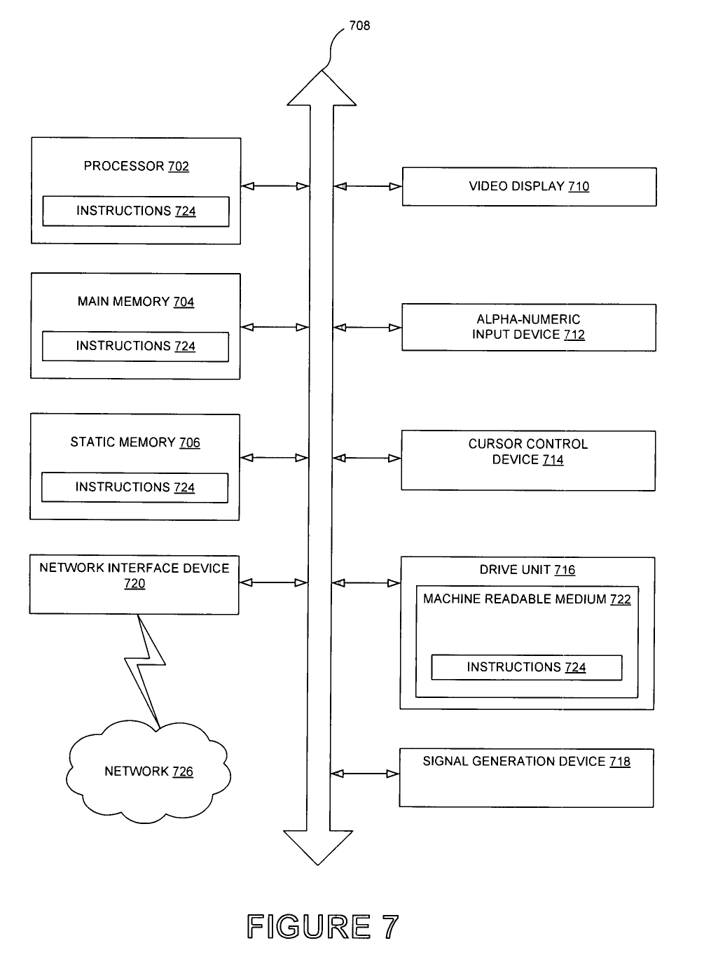

FIG. 7 is a diagrammatic system view 700 of a data processing system in which any of the embodiments disclosed herein may be performed, according to one embodiment. Particularly, the diagrammatic system view 700 of FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724 and a network 726, according to one embodiment.

The diagrammatic system view 700 may indicate a personal computer and/or a data processing system in which one or more operations disclosed herein may be performed. The processor 702 may be a microprocessor, a state machine, an application-specific integrated circuit, a field programmable gate array, etc. (e.g., Intel® Pentium® processor). The main memory 704 may be a dynamic random access memory and/or a primary memory of a computer system. The static memory 706 may be a hard drive, a flash drive, and/or other memory information associated with the data processing system.

The bus 708 may be an interconnection between various circuits and/or structures of the data processing system. The video display 710 may provide graphical representation of information on the data processing system. The alpha-numeric input device 712 may be a keypad, a keyboard and/or any other input device of text (e.g., a special device to aid the physically challenged). The cursor control device 714 may be a pointing device such as a mouse.

The drive unit 716 may be the hard drive, a storage system, and/or other longer term storage subsystem. The signal generation device 718 may be a bios and/or a functional operating system of the data processing system. The network interface device 720 may be a device that may perform interface functions such as code conversion, protocol conversion and/or buffering required for communication to and from a network.

The machine readable medium 722 may provide instructions on which any of the methods disclosed herein may be performed. The instructions 724 may provide source code and/or data code to the processor 702 to enable any one or more operations disclosed herein.

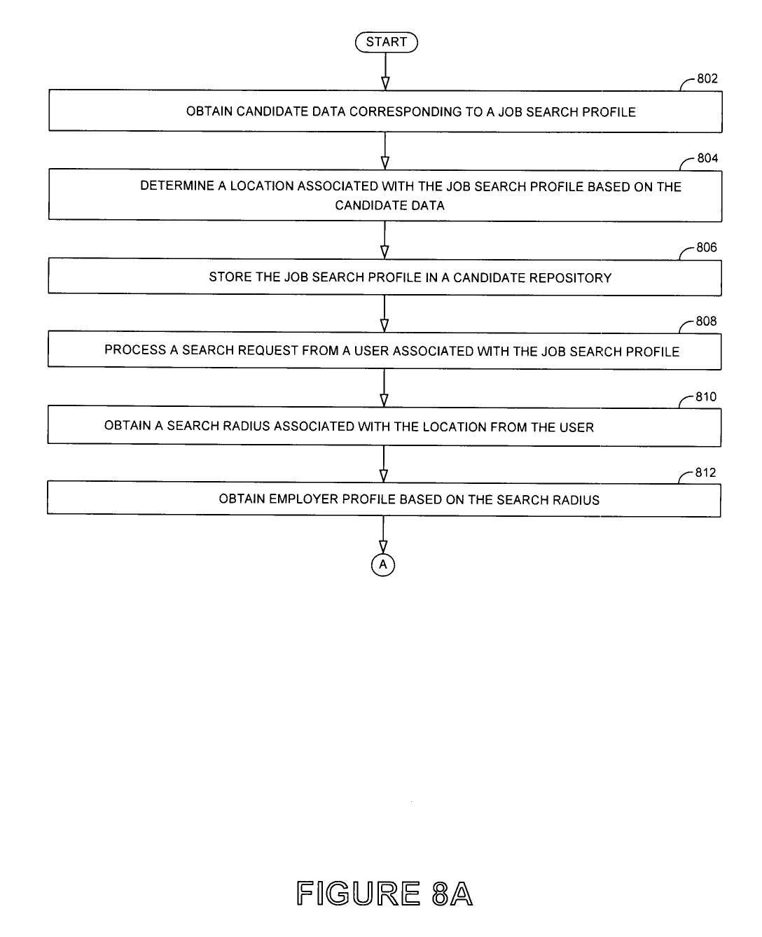

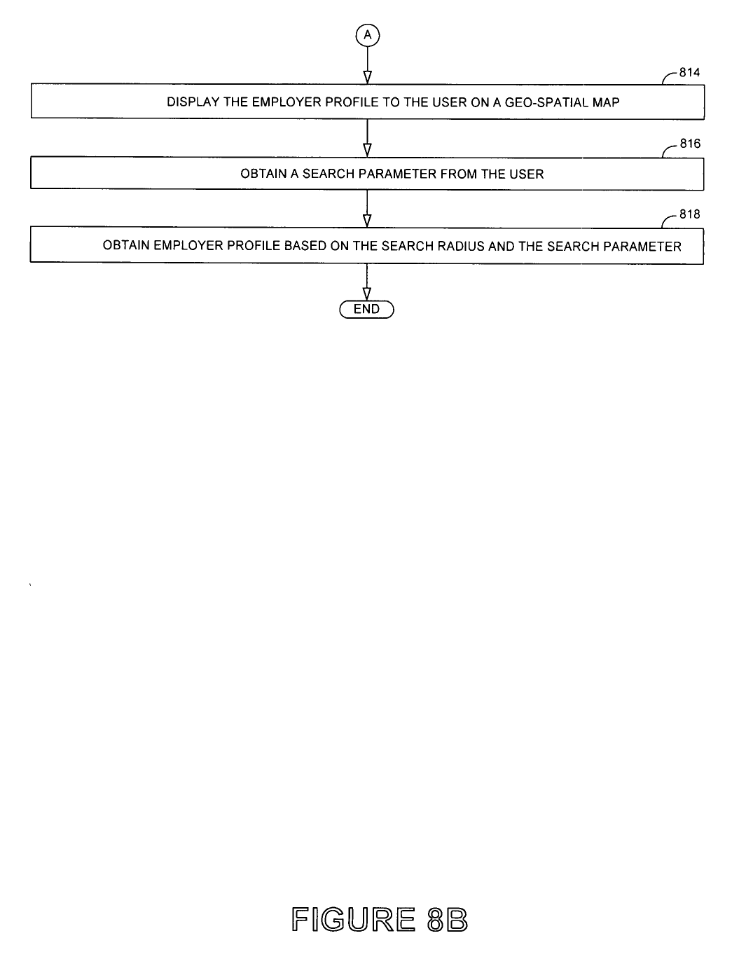

FIG. 8A is a process flow of displaying employer profiles (e.g., the employer profile 400 of FIG. 4) to a user (e.g., candidate) on a geo-spatial map (e.g., the geo-spatial map 200 of FIG. 2A), according to one embodiment. In operation 802, candidate data (e.g., may include name, resume, cover letter, experience level, education level, and/or employment preference, etc.) corresponding to a job search profile (e.g., the job search profile 300 of FIG. 3) may be obtained (e.g., using the candidate repository 114 of FIG. 1).

In operation 804, a location associated with the job search profile 300 may be determined (e.g., using the geo-spatial repository 10 of FIG. 1) based on the candidate data. In operation 806, the job search profile 300 may be stored in a candidate repository (e.g., the candidate repository 114 of FIG. 1). In operation 808, a search request may be processed (e.g., using the search option 208 of FIG. 2A) from the user associated with the job search profile 300.

In operation 810, a search radius (e.g., the search radius 204 of FIG. 2A) associated with the location may be obtained from the user. In operation 812, an employer profile (e.g., the employer profile 400 of FIG. 4) may be obtained (e.g., from the employer repository 112 of FIG. 1) based on the search radius 204.

FIG. 8B is a continuation of the process flow of FIG. 8A illustrating additional processes, according to one embodiment. In operation 814, the employer profile 400 may be displayed (e.g., using the job management module 108 of FIG. 1) to the user on the geo-spatial map 200. In operation 816, a search parameter (e.g., may include job category, job type, keyword, salary range, experience level, and/or education level, etc.) may be obtained from the user. In operation 818, the employer profile 400 may be obtained (e.g., using the job management module 108 of FIG. 1) based on the search radius 204 and the search parameter.

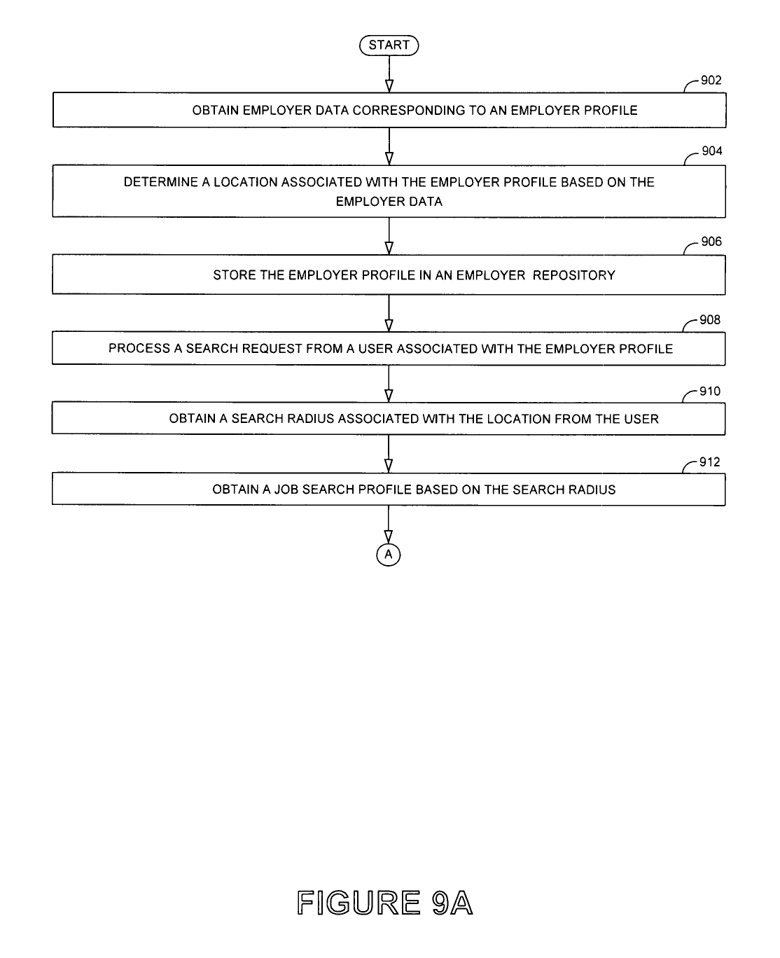

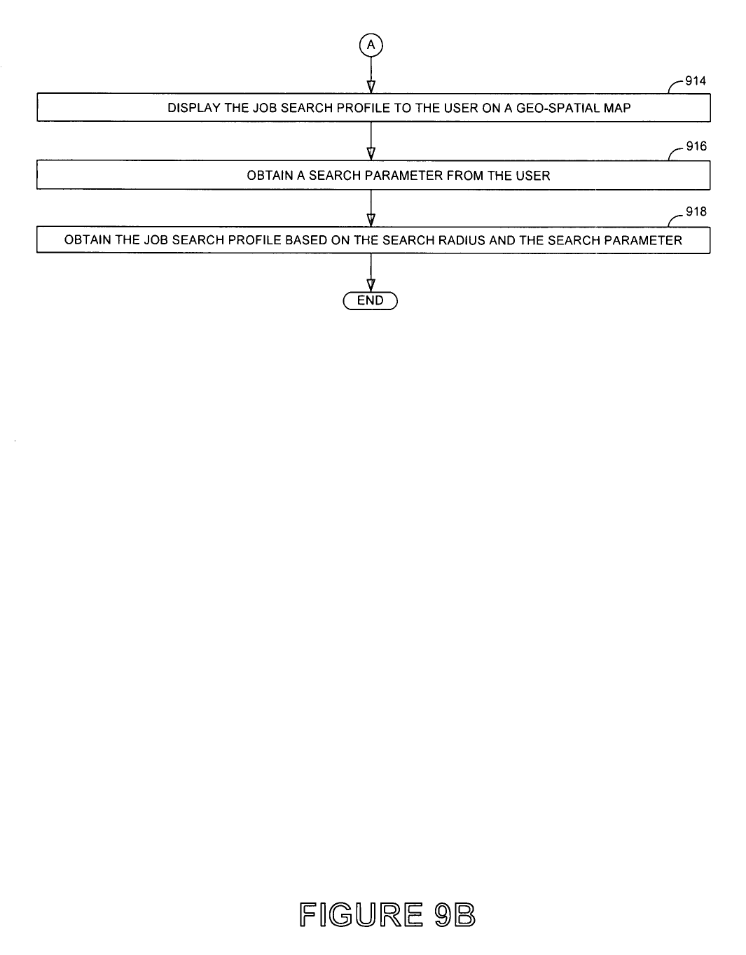

FIG. 9A is a process flow of displaying job search profiles 300 to a user (e.g., employer) on a geo-spatial map (e.g., the geo-spatial map 200 of FIG. 2B and 2C), according to one embodiment. In operation 902, employer data (e.g., may include employer name, employer description, location, education level, experience level, job title, job description, compensation, and/or candidate preference, etc.) corresponding to an employer profile (e.g., the employer profile 400 of FIG. 4) may be obtained. In operation 904, a location associated with the employer profile 400 may be determined (e.g., using the geo-spatial repository 110 of FIG. 1) based on the employer data.

In operation 906, the employer profile 400 may be stored in an employer repository (e.g., the employer repository 112 of FIG. 1). In operation 908, a search request may be processed (e.g., using the search option 232 of FIG. 2C) from the user associated with the employer profile 400. In operation 910, a search radius (e.g., the search radius 204 of FIG. 2) associated with the location may be obtained from the user. In operation 912, a job search profile (e.g., the job search profile 300 of FIG. 3) may be obtained (e.g., from the candidate repository 114 of FIG. 1) based on the search radius 204.

FIG. 9B is a continuation of the process flow of FIG. 9A illustrating additional processes, according to one embodiment. In operation 914, the job search profile 300 may be displayed (e.g., using the job management module 108 of FIG. 1) to the user (e.g., employer) on a geo-spatial map 200. In operation 916, a search parameter (e.g., may include job category, job type, keyword, salary range, experience level, and/or education level, etc.) may be obtained from the user. In operation 918, the job search profile 300 may be obtained (e.g., using the job management module 108 of FIG. 1) based on the search radius 204 and the search parameter.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or in Digital Signal Processor (DSP) circuitry). For example, the job management module 108, and other modules of FIGS. 1-9B may be enabled using a job management circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of conducting a job search, comprising:
obtaining candidate data corresponding to a job search profile;
determining a location associated with the job search profile based on the candidate data;
storing the job search profile in a candidate repository;
processing a search request from a user associated with the job search profile;
obtaining a search radius associated with the location from the user;
obtaining at least one employer profile based on the search radius; and
displaying the at least one employer profile to the user on a geo-spatial map.

2. The method of claim 1, further comprising:
obtaining a search parameter from the user; and
obtaining the at least one employer profile based on the search radius and the search parameter.

3. The method of claim 2, wherein the search parameter is at least one of a job category, a job type, a keyword, a salary range, an experience level, and an education level.

4. The method of claim 1, wherein the candidate data is at least one of a name, a resume, a cover letter, an experience level, an education level, and an employment preference.

5. The method of claim 1, wherein the search radius is at least one of a distance from the location and a commute time from the location.

6. The method of claim 1 in a form of a machine-readable medium embodying a set of instructions that, when executed by a machine, causes the machine to perform the method of claim 1.

7. The method of claim 1, wherein the location comprises a non-residential location.

8. A community network, comprising:
a candidate repository comprising a plurality of job search profiles;
an employer repository comprising a plurality of employer profiles;
a geo-spatial repository comprising a plurality of locations on a geo-spatial map; and
a job management module configured to:
determine a first of the plurality of locations associated with one of the plurality of job search profiles;
process a search request from a first user associated with the one of the plurality of job search profiles;
obtain a first search radius associated with the first of the plurality of locations from the first user;
obtain at least one of the plurality of employer profiles based on the first search radius; and
display the at least one of the plurality of employer profiles to the first user on the geo-spatial map.

9. The community network of claim 8, wherein the job management module is further configured to:
obtain a first search parameter from the first user; and
obtain the at least one of the plurality of employer profiles based on the first search radius and the first search parameter.

10. The community network of claim 9, wherein the first search parameter is at least one of a job category, a job type, a keyword, a salary range, an experience level, and an education level.

11. The community network of claim 8, wherein the job management module is further configured to:
determine a second of the plurality of locations associated with one of the plurality of employer profiles;
process a search request from a second user associated with the one of the plurality of employer profiles;
obtain a second search radius associated with the second of the plurality of locations from the second user;
obtain at least one of the plurality of job search profiles based on the second search radius; and
display the at least one of the plurality of job search profiles to the second user on the geo-spatial map.

12. The community network of claim 1 1, wherein the job management module is further configured to:
obtain a second search parameter from the second user; and
obtain the at least one of the plurality of job search profiles based on the second search radius and the second search parameter.

13. The community network of claim 8, wherein each of the plurality of employer profiles is at least one of an employer name, an employer description, a location, an education level, an experience level, a job title, a job description, a compensation, and a candidate preference.

14. The community network of claim 8, wherein each of the plurality of job search profiles is at least one of a name, a resume, a cover letter, an experience level, an education level, and an employment preference.

15. The community network of claim 8, wherein the first search radius is at least one of a distance from the location and a commute time from the first of the plurality of locations.

16. A method of conducting a job candidate search, comprising:
obtaining employer data corresponding to an employer profile;
determining a location associated with the employer profile based on the employer data;
storing the employer profile in an employer repository;
processing a search request from a user associated with the employer profile;
obtaining a search radius associated with the location from the user;
obtaining at least one job search profile based on the search radius; and
displaying the at least one job search profile to the user on a geo-spatial map.

17. The method of claim 16, further comprising:
obtaining a search parameter from the user; and
obtaining the at least one job search profile based on the search radius and the search parameter.

18. The method of claim 17, wherein the search parameter is at least one of a job category, a job type, a keyword, a salary range, an experience level, and an education level.

19. The method of claim 16, wherein the employer data is at least one of an employer name, an employer description, a location, an education level, an experience level, a job title, a job description, a compensation, and a candidate preference.

20. The method of claim 16, wherein the search radius is at least one of a distance from the location and a commute time from the location.
